(19) United States
(12) Patent Application Publication
(10) Pub. No.: US 2021/0313809 A1
(43) Pub. Date: Oct. 7, 2021

(54) METHOD FOR CONTROLLING AN ELECTRICAL INSTALLATION HAVING A PLURALITY OF ELECTRICAL DEVICES, CONTROL UNIT, AND ELECTRICAL INSTALLATION HAVING SUCH A CONTROL UNIT

(71) Applicant: SMA Solar Technology AG, Niestetal (DE)

(72) Inventors: Marlies Richter, Niestetal (DE); Ferdinand Wikullil, Kassel (DE); Maurice Gonska, Borken (DE); Matthias Groene, Kassel (DE); Mathias Buenemann, Kassel (DE); Alexander Unru, Baunatal (DE); Mats Bernsdorff, Kassel (DE)

(21) Appl. No.: 17/349,074

(22) Filed: Jun. 16, 2021

Related U.S. Application Data
(63) Continuation of application No. PCT/EP2019/080697, filed on Nov. 8, 2019.

(30) Foreign Application Priority Data
Dec. 18, 2018 (DE) 10 2018 132 645.9

(51) Int. Cl. H02J 3/46; H02J 3/14; H02J 3/38

(52) U.S. Cl. CPC H02J 3/46; H02J 3/381; H02J 3/14

(57) ABSTRACT

A method is disclosed for controlling an electrical installation having electrical devices operated in an energy-producing, energy-storing and/or energy-consuming manner and are connected to an energy supply grid. The method includes a first stage which is aimed at achieving an installation target P_{Anl,Soll} for a power flow P_{Anl} assigned to the installation at the grid connection point, and a second stage which is aimed at achieving an individual device target P_{Ger,Soll,i} for a power flow P_{Ger,i} of each device from the plurality of devices. On the basis of detection of a power flow P_{Anl} of the installation at a grid connection point and a comparison of the detected power flow P_{Anl} of the installation with the installation target P_{Anl,Soll}, the installation is operated in the second stage if the detected power flow P_{Anl} of the installation is within a tolerance range around the installation target P_{Anl,soll}, or is otherwise operated in the first stage. A control unit and such an installation are likewise described.

### CROSS REFERENCE TO RELATED APPLICATIONS

This application is a continuation of International Patent Application number PCT/EP2019/080697, filed on Nov. 8, 2019, which claims priority to German Patent Application number 102018132645.9, filed on Dec. 12, 2018, and is hereby incorporated by reference in its entirety.

### FIELD

The disclosure relates to a method for controlling an electrical installation having a plurality of electrical devices, to a control unit configured to carry out the method, and to an electrical installation having such a control unit.

### BACKGROUND

Electricity tariffs for larger energy customers, for example commercial enterprises, generally have a maximum active power to be consumed and often also a minimum active power to be consumed. This is used for better planning of energy production. Exceeding the maximum active power and undershooting the minimum active power obtained from an AC voltage grid via a grid connection point are associated with increased energy costs for the energy customer.

Energy customers often operate an electrical installation comprising a regenerative energy production installation in combination with an energy storage system and electrical consumers. This makes it possible to supply the electrical consumers to the greatest possible extent within the predefined tolerances for the minimum and maximum active power to be obtained. Specifically, an excess of power which is produced within the installation and currently cannot be used by the electrical consumers is fed into the energy storage system and is buffered there. In contrast, when the power consumed overall by the consumers of the energy customer threatens to exceed the maximum active power to be obtained, power is drawn from the energy storage system. This limits a power obtained from the AC voltage grid via a grid connection point and supports a supply of the consumers when power below the maximum active power to be obtained is obtained from the grid.

Regulating such an electrical installation having a plurality of electrical devices, including at least one device which can be operated in an energy-producing manner, one device which can be operated in an energy-storing manner and/or one device which can be operated in an energy-consuming manner, is complex. The complexity increases with the number of different electrical devices within the installation. This is due to the fact that the regulation must take into account, on the one hand, individual device targets for the power flows of the individual devices and, on the other hand, an installation target for the power flow of the entire installation at the grid connection point at the same time. It is not expedient if, although the installation target is achieved, a device or individual devices severely fall(s) short of its/their individual device targets relative to other devices in the installation. Rather, it is desirable for both the installation target and the individual device targets of the individual devices of the installation to be achieved as well as possible for all devices of the installation.

The document DE 102015101738 A1 discloses a method for operating an energy production installation which, for the bidirectional exchange of an electrical exchange power, is connected to a public AC voltage grid via a grid connection point. The energy production installation comprises an energy production unit, an energy store and an electrical consumer. The electrical exchange power of the energy production installation at the grid connection point is adjusted to a desired value by controlling the energy production unit, the energy store and/or the consumer, which desired value is determined on the basis of a first target variable and a second target variable. In this case, the first target variable for the exchange power is predefined as a constant value and the second target value for the exchange power is predefined on the basis of at least one variable captured at the grid connection point.

The document DE 102016110716 A1 discloses a method for adaptively controlling a discharge power of a storage unit assigned to a system. The aim of the control is to limit electrical energy obtained from an energy supply grid via a grid connection point of the system within an averaging interval to a target value. For this purpose, the discharge power of the storage unit is controlled during the averaging interval on the basis of electrical energy already obtained at the current time in the averaging interval, a current time and the target value assigned to the averaging interval.

### SUMMARY

The disclosure is directed to a method for controlling an electrical installation having a plurality of electrical devices comprising a device which can be operated in an energy-producing manner, an electrical device which can be operated in an energy-storing manner and/or a device which can be operated in an energy-consuming manner. The method can be used to achieve both an installation target and individual device targets of the individual devices within the installation as well as possible. The disclosure is also directed to a control unit configured to carry out the method and an electrical installation having a plurality of electrical devices which can be operated differently, and such a control device.

The method according to the disclosure relates to control of an electrical installation having a plurality of electrical devices using a control unit. In this case, the plurality of devices and therefore the installation are connected to a public energy supply grid via a common grid connection point. The installation comprises at least one device which can be operated in an energy-producing manner, at least one device which can be operated in an energy-storing manner and/or one device which can be operated in an energy-consuming manner. The method has a first stage which is aimed at achieving an installation target P_{Anl,Soll} for a power flow P_{Anl} assigned to the installation at the grid connection point. The method also has a second stage which is aimed at achieving an individual device target P_{Ger,Soll,i} for a power flow P_{Ger,i} of each device i from the plurality of devices. In this case, the method comprises:

detecting the power flow P_{Anl} of the installation at the grid connection point,

comparing the detected power flow P_{Anl} of the installation with the installation target P_{Anl,soll}. The method also comprises:

operating the method in the second stage if the detected power flow P_{Anl} of the installation is within a tolerance range around the installation target P_{Anl,soll}, with the result that each device achieves the individual device target P_{Ger,Soll,i} assigned to it in the best possible manner, and operating the method in the first stage if the detected power flow P_{Anl} of the installation is outside the tolerance range around the installation target P_{Anl,soll}, wherein the devices of the installation are regulated in the direction of achieving the installation target P Anl,soll, and wherein the regulation strives for the situation in which, for each device i of the plurality, a difference ΔP_{Ger,i}=P_{Ger,Soll,i}−P_{Ger,i} between the power flow P_{Ger,i} of the device and the respective individual device target P_{Ger,Soll,i} corresponds to a device-specific default value.

According to the application, the term “controlling the installation” should also be understood as meaning, for example, “regulating the installation”. An electrical device which can be operated in an energy-storing manner should be understood as meaning a device which can be operated both in an energy-releasing manner and in an energy-absorbing manner. The plurality n of devices may comprise two devices or a greater number of devices, that is to say n≥2. The power flow of each device P_{Ger,i} and the individual device target for the power flow P_{Ger,Soll,i} can in each case comprise an active power, a reactive power and/or an apparent power. A similar situation applies to the power flow of the installation P_{Ani} and the installation target for the power flow P_{Anl,soll}. The installation target P_{Anl,Soll} can, but need not necessarily, be in the center of the tolerance range. According to the disclosure, it is also possible for the installation target to correspond to a tolerance limit of the tolerance range.

In one embodiment the power flow of the installation P_{Anl} corresponds to the sum of the power flows P_{Ger,i} of the devices according to equation 1:

P_{Anl}=Σᵢ₌ᵢⁿP_{Ger,i} (eq. 1)

The tolerance range around the installation target P_{Anl,Soll} can be understood as meaning a permitted range, such that, when the power flow for the installation P_{Anl} is within the tolerance range, the installation power does not require any correction.

In one embodiment, the individual devices i can control or adjust their respective individual device target P_{Ger,Soll,i} independently of one another within the tolerance range of the installation. In this case, the desired value to be adjusted by the respective device corresponds to the individual device target P_{Ger,Soll,i}. A regulator assigned to the respective device of the installation, in particular a proportional-integral regulator (PI regulator), operates with the aim of regulating an error in the power flow ΔP_{Ger,i} for each device i to 0 according to ΔP_{Ger,i}=P_{Ger,Soll,i}−P_{Ger,i}. In this case, the sum of the power flows P_{Ger,i} of the devices may not be equal to the installation target P_{Anl,soll}, with the result that there is a deviation of the power flow P_{Anl} of the installation from its desired value P_{Anl,soll}. However, as long as this deviation is within the tolerance range, it is disregarded and is not taken into account when regulating the individual device targets P_{Ger,Soll,i}.

In contrast, if the power flow of the installation P_{Anl} at the grid connection point is outside the tolerance range, it is necessary to correct the power flow P_{Anl} of the installation in order to change it into the tolerance range again. In one embodiment all devices i of the installation participate in the correction of the power flow in a predefined manner according to the disclosure.

In particular, a modified desired value \tilde{P}_{Ger,soll,i} can be generated for each device i of the installation on the basis of the relative proportion of the nominal power P_{Ger,nom,i} of the device i in the nominal power P_{Anl,nom} of the installation, wherein the nominal power P_{Anl,nom} corresponds to the sum P_{Anl,nom}=Σᵢ₌₁ⁿP_{Ger,nom,i} of the nominal powers P_{Ger,nom,i} of the devices of the installation.

In one embodiment the desired value \tilde{P}_{Ger,Soll,i} modified for the purpose of correcting the installation power can then be composed as follows according to equation 2:

$${\tilde{P}}_{Ger , Soll , i} = {P}_{Ger , sol l , i} + [ ( {P}_{Anl , sol l} - {P}_{A n l} ) - {\sum }_{j = 1}^{n} ( {P}_{Ger , soll , j} - {P}_{Ger , j} ) ] \frac{{P}_{Ger , no m , i}}{{P}_{A n l , n o m}} \qquad ( eq . 2 )$$

In equation 2, the first summand P_{Ger,Soll,i} describes the individual device target for the power flow of the device i. This value is used if the installation power is in the tolerance range.

The second summand includes a first correction term which is used to distribute the installation error (P_{Anl,Soll}−PAnl) among the individual devices i of the installation. For this purpose, a difference between the power flow P_{Anl} of the installation and its installation target P_{Anl,Soll} can be scaled using the relative proportion of the nominal device power P_{Ger,nom,i} in the nominal installation power P_{Anl,nom}. The distribution of the installation error can therefore be advantageously scaled on the basis of the relative proportions of the respective nominal powers P_{Ger,nom,i} of the devices in the nominal power P_{Anl,nom} of the installation.

The second summand also includes a second correction term which is used to distribute the deviations of the power flows P_{Ger,i} from the respective individual device targets P_{Ger,Soll,i}, which are summed overall across all devices i (with k=1 to n) of the installation, among the individual devices i of the installation. The second summand is used in the first stage of regulation in which the achievement of the installation target P_{Anl,Soll} is prioritized over achieving the individual device targets P_{Ger,Soll,i}, wherein the installation target P_{Anl,Soll} is to be adjusted using the devices i of the installation. In this case, it is possible—and generally also the case—that the devices cannot adjust their individual targets P_{Ger,Soll,i} at the expense of achieving the installation target P_{Anl,soll}. Rather, for the devices of the installation, there is in each case a deviation from their individual device target, which is summed in the second correction term of the second summand. The deviation which is present overall i.e. summed—is then distributed among the individual devices of the installation.

The deviations of the individual devices i from their respective individual device targets are therefore controlled using the second summand, whereas the control unit controls the devices of the installation with the aim of together setting or adjusting the installation target P_{Anl,Soll} of the installation. This prevents an individual device i or a plurality of individual devices i from having an uncontrolled and possibly excessive deviation from its/their individual device target relative to the other devices. For this purpose, the modified desired value \tilde{P}_{Ger,soll,i} is calculated for each device i of the installation, wherein the power flow P_{Ger,i} of the respective device i is adjusted to the modified desired value \tilde{P}_{Ger,soll,i}, that is to say P_{Ger,i}=\tilde{P}_{Ger,soll,i}. The method can therefore be used to set the situation in which a difference ΔP_{Ger,i}=P_{Ger,Soll,i}−P_{Ger,i} between the power flow P_{Ger,i} of the device and the respective individual device target P_{Ger,Soll,i} for each device i of the installation corresponds to a device-specific default value. Since the power flow P_{Ger,i} of the device i is adjusted to the modified desired value \tilde{P}_{Ger,soll,i} according to P_{Ger,i}=\tilde{P}_{Ger,soll,i} in the first stage of the method, this is synonymous with the fact that, in a state in which the power flow P_{Ger,i} of the device i has been adjusted to its accordingly modified desired value \tilde{P}_{Ger,Soll,i}, a difference between the modified desired value \tilde{P}_{Ger,soll,i} and the individual device target P_{Ger,Soll,i} corresponds to a device-specific default value.

In one embodiment of the method, the device-specific default value for each device i of the installation may have an equal relative difference ΔP_{Ger,i}/P_{Ger,nom,i}, which also corresponds to an equal relative difference (P_{Ger,Soll,i}−\tilde{P}_{Ger,soll,i})/P_{Ger,nom,i}, based on a nominal power P_{Ger,nom,i} of the respective device. This results in devices of the installation with a high nominal power P_{Ger,nom,i} also having a great absolute deviation from their individual device target P_{Ger,Soll,i}, whereas devices with an only low nominal power P_{Ger,nom,i} also have only a small absolute deviation from their individual device target.

In an alternative embodiment, the device-specific default values may be selected in such a manner that, for at least one device of the installation, a relative difference ΔP_{Ger,i}/P_{Ger,nom,i} of the power flow based on a respective nominal power P_{Ger,nom,i} differs from the relative differences ΔPGer,k/PGer,Nom,k (with k≠i) of the other devices of the installation. In this case too, the power flow P_{Ger,i} of the device i corresponds to the modified desired value \tilde{P}_{Ger,soll,i} and the difference ΔP_{Ger,i}=(P_{Ger,Soll,i}−P_{Ger,i}) corresponds to the equal difference (P_{Ger,Soll,i}−\tilde{P}_{Ger,soll,i}). In addition, individual devices i within the installation can be controlled in such a manner that they better achieve their individual device target P_{Ger,Soll,i}, whereas the other devices k (with k≠i) have a greater deviation from their individual device target Ger,Soll,i. P Individual devices i within the installation can therefore be prioritized over other devices k as they approach their individual device targets P_{Ger,Soll,i}.

In one embodiment of the method, the relative differences ΔP_{Ger,i}/P_{Ger,nom,i} of the power flows from the individual device targets P_{Ger,Soll,i} can be adjusted using different weighting factors Xᵢ assigned to the devices i. For example, the weighting factors Xᵢ can be selected in such a manner that a relative difference of the power flow ΔP_{Ger,i}/P_{Ger,nom,i}, multiplied by the respective weighting factor Xᵢ, assumes a constant value for each device i of the installation. In other words, it is possible to use an approach according to

$${X}_{i} \frac{( {P}_{Ger , soll , i} - {P}_{Ger , i} )}{{P}_{Ger , nom , i}} = {X}_{i} \frac{( {P}_{Ger , soll , i} - {\tilde{P}}_{Ger , soll , i} )}{{P}_{Ger , nom , i}} = const for all i ( 1 to n ) \qquad ( eq . 3 )$$

It therefore follows in this case that as a device i better achieves its individual device target, the higher the weighting factor Xᵢ of the corresponding device i. As an alternative to the above-mentioned approach, however, the weighting factors Xᵢ can also be selected in such a manner that a low weighting factor results in the corresponding device i being brought closer to its individual device target P_{Ger,Soll,i}. This can be achieved, for example, using weighting factors which are reciprocal to the weighting factors Xᵢ.

In one embodiment of the method, the individual device targets P_{Ger,Soll,i} of the individual devices i may vary or be varied over time. For example, the power flow of a bidirectionally operating battery inverter, as part of a device of the installation, may depend on a state of charge of a battery connected to the battery inverter on the input side, wherein the state of charge of the battery varies over time. Alternatively or additionally, the power flow of a photovoltaic (PV) inverter, as part of an electrical device of the installation, can vary over time, for example on account of thermal boundary conditions of the inverter. It can also vary as a result of a supply of the power flow into an energy supply grid connected to the installation being limited by the energy supply company.

A temporal variation in the individual device target P_{Ger,Soll,i} for the power flow of a device may be provided and/or temporally varied by the one device itself. This is the case in a battery inverter, for example, when its control itself ensures that a certain state of charge of the battery is complied with. In the case of the PV inverter as part of an electrical device, control of the PV inverter may cause a reduction in the individual device target P_{Ger,Soll}, for example on account of temperature measurements within the device.

Sometimes, it may be advantageous for the device targets P_{Ger,Soll,i} of individual devices i to not be provided by the devices themselves. Alternatively or additionally, the individual device target P_{Ger,Soll,i} of a device or the individual device targets P_{Ger,Soll,i} of a plurality of devices, optionally of all devices, therefore cannot be provided and/or temporally varied by the devices themselves, but rather by a superordinate energy management system. This is advantageous, in particular, when the device targets P_{Ger,Soll,i} depend on one another. It goes without saying that it is also possible for individual devices to determine their device targets P_{Ger,Soll,i} themselves, while the device targets P_{Ger,Soll,i} of other devices within the electrical installation are provided by the superordinate energy management system.

In a further embodiment of the method, the installation target P_{Anl,Soll} and/or the tolerance band around the installation target P_{Anl,Soll} may temporally vary. Such temporal variations may result on account of a state change of the energy supply grid. For example, properties of an AC voltage—for example a frequency and/or a voltage amplitude of the AC voltage—can indicate that there is an excess supply of electrical power in the energy supply grid. The installation can then react to such state changes of the energy supply grid in a grid-supporting manner and can control the exchange of power with the energy supply grid by varying the installation target P_{Anl,Soll} and/or the tolerance band around the installation target P_{Anl,soll}. For example, the installation target P_{Anl,Soll} and/or the tolerance band around the installation target P_{Anl,Soll} can be determined by detecting the frequency, voltage, active power and/or reactive power at the grid connection point and taking into account a characteristic curve, in particular an active power/frequency characteristic curve (P(f)), a reactive power/voltage characteristic curve (Q(U)), a reactive power/active power characteristic curve (Q(P)) and/or a phase shift/active power characteristic curve (cos_phi(P)).

As an alternative, or in addition to reacting to properties of the AC voltage in the energy supply grid, the installation target P_{Anl,Soll} and/or the tolerance band around the installation target of the installation can also be directly communicated. Specifically, the installation target P_{Anl,Soll} and/or the tolerance band around the installation target P_{Anl,Soll} can be predefined by an operator of the energy supply grid by radio or in a wired manner, for example.

In a further embodiment of the method for controlling an electrical installation, the method acts can be run through repeatedly, in particular can be run through repeatedly at regular intervals of time. This results in continuous control or regulation of the installation that can take into account changed device targets P_{Ger,Soll,i} and/or installation targets P_{Anl,Soll} over an extended period.

A control unit or circuit according to the disclosure is designed and configured to control, in particular regulate, an electrical installation according to the disclosure. In this case, the installation comprises a plurality of electrical devices. The installation includes at least one device which can be operated in an energy-producing manner and/or at least one device which can be operated in an energy-storing manner—that is to say both in an energy-releasing manner and in an energy-absorbing manner—and/or at least one device which can be operated in an energy-consuming manner. The control unit is configured to carry out the method according to the disclosure. The control unit may be in the form of a separate control unit of the installation. Alternatively, the control unit may also be in the form of a control unit which is integrated in a device of the installation. The control unit may be connected to the devices of the installation which can be operated in an energy-producing, energy-consuming or energy-producing and energy-consuming manner for the purpose of communication and data interchange. The control unit may optionally also be connected to one or more measurement devices in order to detect properties of an AC voltage or of a power flow at the grid connection point—in particular a frequency, a voltage, an active power and/or a reactive power. The control unit may be configured to determine an installation target P_{Anl,Soll} and/or a tolerance band around the installation target P_{Anl,Soll} for a power flow P_{Anl} of the installation from the detected properties, taking into account characteristic curves known to the control unit. The control unit may also be connected to an energy management system assigned to the installation and may be designed to receive individual device targets P_{Ger,Soll,i} for a power flow of the individual devices of the installation from the energy management system and to take them into account when controlling the installation. The control unit may also be connected to a communication device in order to receive an installation target P_{Anl,Soll} from an operator of the energy supply grid by radio or in a wired manner and to take it into account when controlling the installation.

An energy-consuming and/or energy-producing electrical installation comprises a plurality of electrical devices. The plurality of devices include at least one device which can be operated in an energy-producing manner, at least one device which can be operated in an energy-storing manner—that is to say both in an energy-releasing manner and in an energy-absorbing manner—and/or at least one device which can be operated in an energy-consuming manner. The installation comprises a control unit or circuit according to the disclosure. In this case, at least one of the electrical devices may have an inverter. The inverter may comprise a photovoltaic (PV) inverter, to the DC input of which a PV generator is connected. Alternatively, the inverter may also comprise a battery inverter, the DC input of which is connected to a battery. The battery inverter can be operated in a bidirectional manner in order to charge and discharge the battery. If the installation has a consumption unit operating in an energy-consuming manner as an electrical device, the consumption unit may comprise a connection unit and a consumer connected to the connection unit. The control unit of the installation is connected to the connection unit and is configured—possibly in conjunction with a controller of the connection unit—to control a power flow to the consumer. The electrical installation may additionally have further electrical devices, in particular electrical devices operating in an energy-consuming manner, which cannot be controlled via the control unit. The advantages which have already been mentioned in connection with the method result for the control unit according to the disclosure and also for the installation according to the disclosure.

### BRIEF DESCRIPTION OF THE FIGURES

The disclosure is illustrated below with the aid of figures, in which

FIG. 1 shows an embodiment of an electrical installation according to the disclosure; and

FIG. 2 shows a flowchart of the method according to the disclosure for controlling an electrical installation according to the disclosure.

### DETAILED DESCRIPTION

The electrical installation comprises a plurality of electrical devices and includes at least one device which can be operated in an energy-producing manner, one device which can be operated in an energy-consuming manner and/or at least one device which can be operated both in an energy-releasing manner and in an energy-absorbing manner. The latter may be, in particular, an energy storage system having a battery.

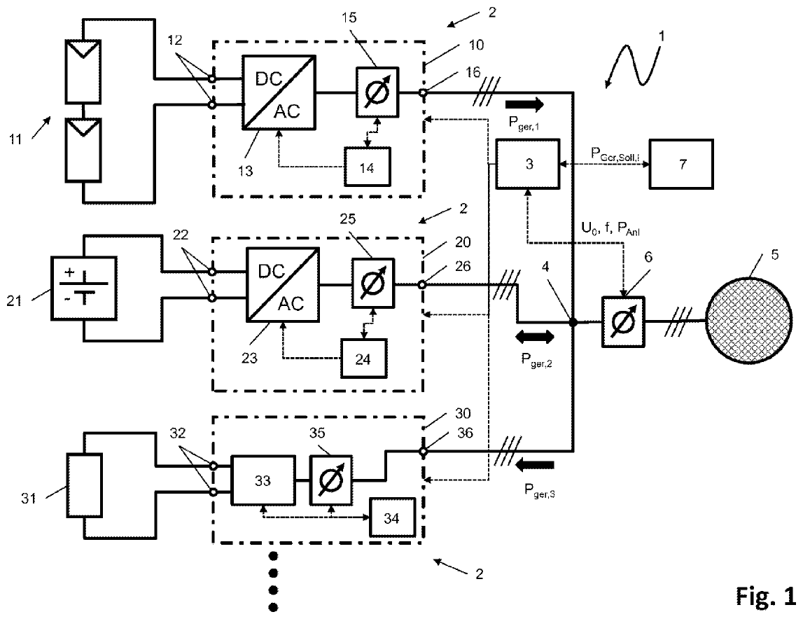

FIG. 1 illustrates an electrical installation 1 according to the disclosure in one embodiment. By way of example, the installation 1 comprises three electrical devices 2 which are connected to an energy supply grid 5 via a common grid connection point 4. A first device 2 of the installation is in the form of a photovoltaic unit and has a photovoltaic inverter 10, to the DC input 12 of which a PV generator 11 is connected. The PV inverter 10 comprises a DC/AC converter 13 controlled by a controller 14. The controller 14 is connected to a measurement device 15 which is used to detect a property of an electrical power PGer,1 flowing via an AC connection 16. The property may comprise an active, reactive and/or apparent power. In one embodiment the controller 14 has a proportional-integral regulator (PI regulator) and is configured to regulate the power flow PGer,1 of the PV inverter 10, which is transferred via the AC connection, to a predefined desired value. The installation 1 also comprises a battery unit as a second electrical device 2, which has a battery inverter 20 which can be operated in a bidirectional manner and to the DC connection 22 of which a rechargeable battery 21 is connected. The battery inverter 20 also has a DC/AC converter 23, a measurement device 25 and a controller 24 for controlling the DC/AC converter 23. In a similar manner to the measurement device 15 of the PV inverter 10, the measurement device 25 of the battery inverter 20 is also designed to detect a property of an electrical power PGer,2 flowing via an AC connection 26, for example an active, reactive and/or apparent power of the battery inverter 20. In a similar manner to the controller 14 of the PV inverter 10, the controller 24 of the battery inverter 20 also includes a PI regulator and is designed to regulate a power flow PGer,2 of the battery inverter 20, flowing via an AC connection 26, to a desired value. As a third electrical device 2, the installation 1 comprises a consumer unit having a connection unit 30 and a consumer 31 connected to an input connection 32 of the connection unit 30. An output connection 36 of the connection unit 30 is connected to the grid connection point 4 of the installation 1. A power flow PGer,3 flowing in the direction of the consumer 31 can also be varied, in particular reduced, by the connection unit 30. For this purpose, the connection unit 30 has a power limiter 33, a measurement device 35 for detecting a property of the power flow PGer,3 transferred in the direction of the consumer 31 and a controller 34 for controlling the power limiter 33. The consumer 31 may be a consumer which can be operated with an AC voltage. Alternatively, the consumer 31 may also be in the form of a DC voltage consumer. In this case, the connection unit 30 may also include an AC/DC converter in addition to the components illustrated. In one embodiment, the consumer 31 may be in the form of a heating element or a charging post for charging an electric vehicle, for example.

The installation 1 also comprises a superordinate control unit 3 or circuit for controlling the electrical devices 2. The control unit 3 is connected to an energy management system 7. The energy management system 7 determines and communicates individual device targets P_{Ger,Soll,i} for the individual devices 2 of the installation 1 to the control unit 3. The control unit 3 is also connected to a measurement device 6 for detecting a property of an AC voltage of the energy supply grid. For this purpose, the measurement device 6 is connected to the energy supply grid 5 on a side of the grid connection point facing the energy supply grid. The property detected by the measurement device 6 may be an amplitude U0 and/or a frequency f of the AC voltage. The measurement device 6 is also able to detect a property of a power flow P_{Anl} exchanged between the energy supply grid 5 and the installation 1. The property of the power flow P_{Anl} may be an active, reactive and/or apparent power.

The control unit 3 is designed and configured to carry out the method according to the disclosure. For this purpose, the control unit 3 is aware of an installation target P_{Anl},son for a power flow P_{Anl} of the installation 1, which is transferred via the grid connection point 4, and a tolerance range around the installation target P_{Anl,soll}. The installation target P_{Anl,Soll} may arise, in one embodiment, taking into account a tariff agreement for the power obtained from the energy supply grid and may be stored in the control unit 3 or the energy management system 7. Alternatively, the installation target P_{Anl,Soll} and possibly the tolerance range around the installation target P_{Anl,Soll} may be determined by the control unit 3 from the properties of the AC voltage in the energy supply grid 5 which are detected by the measurement device 6 at the grid connection point 4. For this purpose, the control unit 3 may take into account characteristic curves, for example an active power/frequency characteristic curve (P(f)), a reactive power/voltage characteristic curve (Q(U)), a reactive power/active power characteristic curve (Q(P)) and/or a phase shift/active power characteristic curve (cos_phi(P)).

In FIG. 1, the electrical installation 1 is illustrated, by way of example, as a three-phase installation, in which each of the three phase conductors is respectively connected to a corresponding phase conductor of the three-phase energy supply grid 5. This is symbolized in FIG. 1 by three forward slashes on both sides of the grid connection point 4. However, within the scope of the disclosure, it is alternatively possible for the installation to have a different number of phase conductors and to be in the form of a single-phase or two-phase installation, for example. In this case, the one phase conductor or each of the two phase conductors is connected to a corresponding phase conductor of the energy supply grid 5. The installation may have further energy-producing, energy-consuming and both energy-producing and energy-consuming devices 2, which is symbolized in FIG. 1 by dots below the connection unit 30. These may also be devices which cannot or are not controlled via the control unit 3.

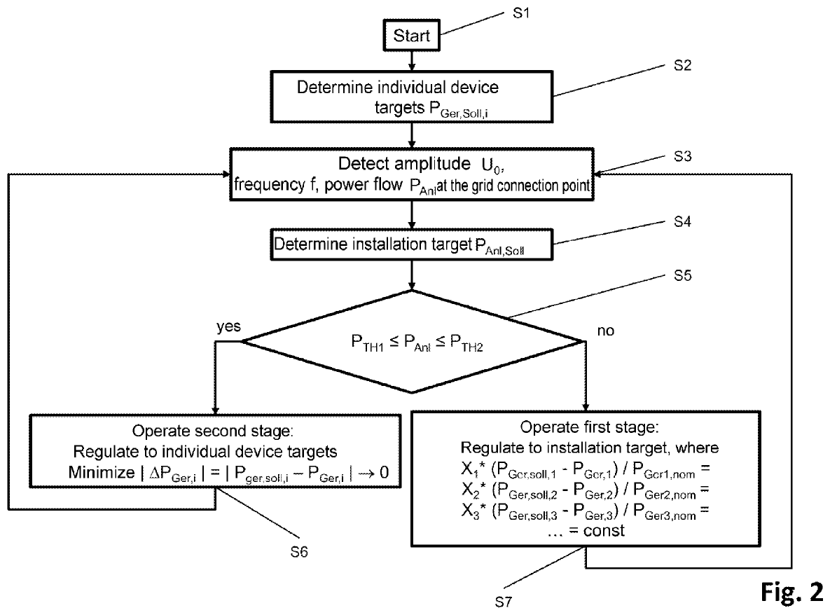

FIG. 2 illustrates an embodiment of the method in the form of a flowchart, which is explained by way of example below using the example of the electrical installation from FIG. 1.

The method starts at S1. In the following, at S2, individual device targets P_{Ger,Soll,i} are determined for each device i of the installation 1, for example by the energy management system 7. At S3, properties of the AC voltage at the grid connection point 4 of the installation 1 are detected by the measurement device 6. In one embodiment, an amplitude U0, a frequency f and a power flow P_{Anl} of the installation 1 are detected. These properties are transmitted to the control unit 3.

At S4, the control unit 3 determines an installation target P_{Anl,Soll} of the installation 1 and a tolerance range around the installation target P_{Anl,Soll} from the properties of the AC voltage which are detected at the grid connection point 4 and taking into account characteristic curves. The installation target P_{Anl,Soll} is within the tolerance range. In this case, it is possible for the installation target to correspond to one of the threshold values. For example, an installation target P_{Anl,Soll} for an active power component of the power flow P_{Anl} of the installation 1 and the tolerance range assigned to the installation target can be determined on the basis of the detected frequency f and taking into account an active power/frequency characteristic curve P(f). In one embodiment, the tolerance range is defined, by way of example, by a lower threshold value P_{TH1}, with P_{TH1}≤P_{Anl,soll}, and an upper threshold value P_{TH2}, with P_{TH2}≥P_{Anl,soll}, for the power flow, in particular its active power component, for example.

At S5, the power flow P_{Anl} of the installation 1, determined at the grid connection point 4 at S3, is compared with the tolerance range around the installation target P_{Anl,soll}. If the power flow P_{Anl} transferred via the grid connection point 4 is within the tolerance range around the installation target P_{Anl}—that is to say when P_{TH1}≤P_{Anl}≤P_{TH2} applies to the power flow P_{Anl} of the installation 1—the method branches to S6 in which the installation 1 is operated in the second stage by the control unit 3. For this purpose, the individual device targets P_{Ger,Soll,i} are communicated to the respective regulators of the devices 2 of the installation 1. Each of the regulators for the plurality of electrical devices may be arranged in the electrical device assigned to it. Alternatively, the regulators may also be arranged together within the control unit. If the regulators are arranged in the devices 2, the control unit 3 signals to the devices 2 of the installation 1 that the power flow P_{Anl} of the installation 1 is within the tolerance range around the installation target P_{Anl,Soll} or the method is operated in the second stage. In a situation in which the regulators are arranged in the control unit 3, corresponding signaling is not required. In response to this, each device 2 of the installation 1 is regulated in such a manner that its power flow P_{Ger,i} achieves or corresponds to the respective device target P_{Ger,Soll,i} in the best possible manner. This regulation may be carried out via the controllers 14, 24, 34 of the individual electrical devices 2 or by the regulators arranged inside the control unit 3.

The method finally jumps back to S3 in which the power flow P_{Anl} of the installation 1 flowing via the grid connection point 4 as well as the amplitude U0 and the frequency f of the AC voltage are detected again by the measurement device 6.

If the power flow P_{Anl} of the installation 1 that is transferred via the grid connection point 4 is outside the tolerance range around the installation target P_{Anl,Soll}—that is to say when P_{TH1}≤P_{Anl}≤P_{TH2} does not apply—the method branches to S7 in which the method according to the disclosure is operated by the control unit 3 in the first stage. Here, the aim is to modify the power flow P_{Anl} of the installation 1, which is exchanged with the energy supply grid 5, in the direction of the installation target P_{Anl,soll}, at least such that the power flow changes again into the tolerance range around the installation target P_{Anl}.

If the regulators of the devices 2 are arranged in the respective devices 2, the control unit 3 signals to the devices 2 of the installation 1 that the method is operated in the first stage. In a situation in which the regulators of the devices 2 are arranged in the control unit 3, such signaling is not required. Modified desired values \tilde{P}_{Ger,soll,i} or a variable \tilde{P}_{Ger,soll,i} comprising the modified desired values \tilde{P}_{Ger,soll,i}, for example a modified difference between the modified desired value and the power flow of the device according to (\tilde{P}_{Ger,soll,i}−P_{Ger,i}), is/are then communicated to the regulators of the electrical devices 2. The modified desired values \tilde{P}_{Ger,soll,i} comprise a first correction term, which depends on a difference between the power flow P_{Anl} and the installation target P_{Anl,Soll} of the installation 1, and a second correction term which takes into account a deviation of the power flows P_{Ger,i} of the individual devices from their respective individual device targets P_{Ger,Soll,i}, which is present overall (i.e. summed over all devices), and is used to distribute the deviation Σᵢ₌₁ⁿ (P_{Ger,soll,i}−P_{Ger,i}) which is present overall among the individual devices i of the installation 1. In this case, the distribution may be carried out in an unweighted manner or possibly in a manner weighted with weighting factors Xᵢ. The second correction term ensures that the difference ΔP_{Ger,i}=P_{Ger,Soll,i}−P_{Ger,i} between the power flow P_{Ger,i} and the respective individual device target P_{Ger,Soll,i} for each device of the installation 1 corresponds to a device-specific default value.

1. A method for controlling an electrical installation having a plurality of electrical devices using a control circuit, wherein the installation is connected to an energy supply grid via a common grid connection point, and wherein the plurality of devices are selected from a device which can be operated in an energy-producing manner, a device which can be operated in an energy-storing manner and a device which can be operated in an energy-consuming manner, wherein the method includes
a first stage of operation which is aimed at achieving an installation target P_{Anl,Soll} for a power flow P_{Anl} assigned to the installation at the grid connection point, and
a second stage of operation which is aimed at each device achieving an individual device target P_{Ger,Soll,i} for a power flow P_{Ger,i} of the respective device, the method comprising:
detecting a power flow P_{Anl} of the installation at the grid connection point,
comparing the detected power flow P_{Anl} of the installation with the installation target P_{Anl,soll} of the installation,
operating the method in the second stage when the power flow P_{Anl} of the installation is within a tolerance range around the installation target P_{Anl,soll}, with the result that each device is controlled to achieve the individual device target P_{Ger,Soll,i} assigned thereto so that an absolute value of a difference between each device target for the power flow P_{Ger,Soll,i} and the actual power for the respective device P_{Ger,i} is minimized for all i=1 . . . n, and
operating the method in the first stage when the power flow P_{Anl} of the installation is outside the tolerance range around the installation target P_{Anl,soll}, wherein the devices of the installation are regulated in a direction of achieving the installation target P_{Anl,soll} so that, for each device, a difference ΔP_{Ger,i}=P_{Ger,soll,i} P_{Ger,i} between the respective power flow P_{Ger,i} of the device and the respective individual device target P_{Ger,soll,i} corresponds to a device-specific default value.

2. The method of claim 1, wherein the device-specific default value for each device is selected so that an equal relative deviation ΔP_{Ger,i}/P_{Ger,Nom,i} based on a nominal power P_{Ger,Nom,i} of the respective device results for the devices.

3. The method of claim 1, wherein the device-specific default value for each device is selected so that, for at least one device of the installation, a relative deviation ΔP_{Ger,i}/P_{Ger,Nom,i} of the power flow based on a nominal power of this device differs from relative deviations ΔP_{Ger,j}/P_{Ger,Nom,j} of the other devices of the installation.

4. The method of claim 3, wherein the relative deviations ΔP_{Ger,i}/P_{Ger,Nom,i} of the power flows from the individual device targets are adjusted using different weighting factors Xᵢ assigned to the devices.

5. The method of claim 1, wherein the individual device targets P_{Ger,soll,i} of the devices of the installation vary over time.

6. The method of claim 1, wherein the individual device target P_{Ger,soll,i} for the power flow of a particular device of the installation is provided and/or temporally varied by the particular device itself.

7. The method of claim 1, wherein the individual device targets P_{Ger,soll,i} for the power flows of the devices of the installation are provided and/or temporally varied by a superordinate energy management system.

8. The method of claim 1, wherein the installation target P Anl,Soll and/or the tolerance band around the installation target P_{Anl,soll} temporally varies/vary.

9. The method of claim 8, wherein the installation target P_{Anl,Soll} and/or the tolerance band around the installation target P_{Anl,Soll} is/are determined by detecting a frequency, voltage, active power and/or reactive power at the grid connection point and taking a characteristic curve into account, wherein the characteristic curve comprises an active power/frequency characteristic curve (P(f)), a reactive power/voltage characteristic curve (Q(U)), a reactive power/active power characteristic curve (Q(P)) and/or a phase shift/active power characteristic curve (cos_phi(P)).

10. The method of claim 1, wherein the installation target P_{Anl,Soll} and/or the tolerance band around the installation target P_{Anl,Soll} is/are predefined by an operator of the energy supply grid by radio or in a wired manner.

11. The method of claim 1, wherein the method acts are run through repeatedly at regular time intervals.

12. A control circuit for controlling an electrical installation, wherein the installation comprises a plurality of electrical devices, including a device operated in an energy-producing manner, a device operated in an energy-storing manner and/or a device operated in an energy-consuming manner, wherein the control circuit is designed and configured to:
operate the electrical installation in a first stage of operation which is aimed at achieving an installation target P_{Anl,Soll} for a power flow P_{Anl} assigned to the installation at the grid connection point, and
operate the electrical installation in a second stage of operation which is aimed at each device achieving an individual device target P_{Ger,Soll,i} for a power flow P_{Ger,i} of the respective device, the control circuit is configured to:
detect a power flow P_{Anl} of the installation at the grid connection point,
compare the detected power flow P_{Anl} of the installation with the installation target P_{Anl,Soll} of the installation,
operate the electrical installation in the second stage when the power flow P_{Anl} of the installation is within a tolerance range around the installation target P_{Anl,soll}, with the result that each device is controlled to achieve the individual device target P_{Ger,Soll,i} assigned thereto so that an absolute value of a difference between each device target for the power flow P_{Ger,Soll,i} and the actual power for the respective device P_{Ger,i} is minimized for all i=1 . . . n, and
operate the electrical installation in the first stage when the power flow P_{Anl} of the installation is outside the tolerance range around the installation target P_{Anl,soll}, wherein the devices of the installation are regulated in a direction of achieving the installation target P_{Anl,soll} so that, for each device, a difference ΔP_{Ger,i}=P_{Ger,soll,i}−P_{Ger,i} between the respective power flow P_{Ger,i} of the device and the respective individual device target P_{Ger,soll,i} corresponds to a device-specific default value.

13. An energy-consuming and/or energy-producing electrical installation having a plurality of electrical devices, wherein the installation comprises at least one device operated in an energy-producing manner, at least one device operated in an energy-storing manner and/or at least one device operated in an energy-consuming manner, and a control circuit configured to:
operate the electrical installation in a first stage of operation which is aimed at achieving an installation target P_{Anl,Soll} for a power flow P_{Anl} assigned to the installation at the grid connection point, and
operate the electrical installation in a second stage of operation which is aimed at each device achieving an individual device target P_{Ger,Soll,i} for a power flow P_{Ger,i} of the respective device, the control circuit is configured to:
detect a power flow P_{Anl} of the installation at the grid connection point,
compare the detected power flow P_{Anl} of the installation with the installation target P_{Anl,Soll} of the installation,
operate the electrical installation in the second stage when the power flow P_{Anl} of the installation is within a tolerance range around the installation target P_{Anl,soll}, with the result that each device is controlled to achieve the individual device target P_{Ger,Soll,i} assigned thereto so that an absolute value of a difference between each device target for the power flow P_{Ger,Soll,i} and the actual power for the respective device P_{Ger,i} is minimized for all i=1 . . . n, and
operate the electrical installation in the first stage when the power flow P_{Anl} of the installation is outside the tolerance range around the installation target P_{Anl,soll}, wherein the devices of the installation are regulated in a direction of achieving the installation target P_{Anl,soll} so that, for each device, a difference ΔP_{Ger,i}=P_{Ger,soll,i}−P_{Ger,i} between the respective power flow P_{Ger},i of the device and the respective individual device target P_{Ger,Soll,i} corresponds to a device-specific default value.

14. The energy-consuming and/or energy-producing installation of claim 13, wherein at least one of the electrical devices comprises a photovoltaic inverter or a battery inverter.
